(19) United States
(12) Patent Application Publication
(10) Pub. No.: US 2018/0134901 A1
(43) Pub. Date: May 17, 2018

(54) RENEWABLE BIOMASS DERIVED CARBON MATERIAL AND METHOD OF MAKING THE SAME

(71) Applicant: Carbon Research & Development, Co., Daytona Beach Shores, FL (US)

(72) Inventor: Daniel W. Mulqueen, Charleston, SC (US)

(73) Assignee: Carbon Research & Development, Co., Daytona Beach Shores, FL (US)

(21) Appl. No.: 15/808,456

(22) Filed: Nov. 9, 2017

Related U.S. Application Data
(60) Provisional application No. 62/420,931, filed on Nov. 11, 2016.

(51) Int. Cl. C09C 1/60; C09C 1/48

(52) U.S. Cl. CPC C09C 1/60; C09C 1/48; C01P 2006/80; C01P 2006/12; C01P 2006/11; C01P 2004/61

(57) ABSTRACT

A method for the production of a carbon material entirely from raw biomass feedstock for use as a reinforcing agent, a filler or a pigment in rubbers and plastics and as a replacement for carbon black. The carbon material has a carbon content of greater than 50% by volume of non-volatile, high purity fixed elemental carbon, is free of environmentally hazardous chemical compounds and components surface area, and includes specific properties, such as density, hardness, or chemical composition to provide superior properties as a reinforcing agent.

### CROSS REFERENCE TO RELATED APPLICATIONS

This application claims the benefit of U.S. Provisional Patent Application Ser. No. 62/420,931, filed Nov. 11, 2016, which is incorporated herein by reference in its entirety as if fully set forth herein.

### FIELD OF THE INVENTION

The present invention relates to a novel composition of matter having application for use as a reinforcing agent and filler in rubbers and plastics as well as a pigment and the method for its manufacture. More specifically, the present invention relates to a novel composition of matter and the method for its manufacture for use as a replacement for carbon black material as a binder in rubbers and plastics, a pigment, and in other applications where carbon blacks are used.

### BACKGROUND OF THE INVENTION

Carbon black describes a category of materials characterized by a very high purity of elemental carbon, a very small particle size on the order of microns, and a high surface-area-to-volume ratio. Carbon black materials are used broadly in applications as a reinforcing material in the production of rubbers and plastics, as a pigment, and in other diverse industrial applications where its properties are used to improve materials.

Carbon black has been produced primarily by two processes, the thermal process and the furnace process. Since the 1970's, most carbon blacks have been produced using the furnace process and are referred to as furnace blacks. The furnace process uses a heavy oil as a feedstock, which is sprayed into a hot reactor (heated by combustion of natural gas or another fuel) under carefully controlled conditions so that the oil pyrolysis into small carbon black particles. The thermal process uses a pair of furnaces which cycle between heating (using natural gas as a fuel) and the over rich reaction of natural gas, which decomposed into hydrogen and carbon black.

Both of these processes rely on the use of fossil fuels as feedstock and fuel. This results in the production of over two tonnes of fossil CO₂ emitted per tonne of carbon black produced. Further, these processes produce, as a by-product, polycyclic aromatic hydrocarbons (“PAHs”) which are readily absorbed into the carbon black and contaminate the final product. PAHs are a known human carcinogen and can pose a health risk to humans in contact with materials containing PAHs.

Precipitated Silica has been used as a replacement for carbon black. However, the cost of these materials is roughly double the cost of similar carbon black materials.

U.S. Pat. No. 2,098,429 A, issued on Nov. 9, 1937, to John D Morron for “Rubber Compound” (the “‘429 patent”) discloses a hard rubber compound containing wood charcoal as a substitute carbon black. The wood charcoal described is inexpensive, lightweight, and functionally equivalent to furnace black. The wood charcoal absorbs gases produced by the rubber compound during vulcanization and has a particle size of less than 260 mesh (63 microns) and preferably less than 300 .mesh (53 micron).

U.S. Pat. No. 3,420,913 A, for “Activated Charcoal in Rubber Compounding” issued to Henry E Railsback on Jan. 7, 1969 (the “‘913 patent”), describes the use of activated charcoal in addition to carbon black for rubber compounding. The activated carbon may be produced from wood, bone, nut shells, lignin, coal, and, petroleum residues and must have a particle size of less than 100 mesh (149 micron), preferably less than 325 mesh (44 micron).

U.S. Pat. No. 8,809,441 B2, issued on Aug. 19, 2014 to James H. Sealey and Douglas R. Sedlacek for “Method of Reinforcing Rubber and Rubber Composition” (the “‘441 patent”), discloses a rubber composition utilizing an activated charcoal of greater than 0.15 cc/g and less than 130 micron diameter as the primary filler. This rubber is used primarily in the production of carbon belts. Several proposed blends are suggested using various activated carbon fillers.

All three of the above listed patents, are focused specifically on the rubber compound, not on the carbon filler used to make the compound. The ‘441 patent specifically lists several activated carbons as possible fillers. The ‘913 patent and the ‘441 patent both focus on activated charcoal, which requires multi-step processing and is costly. The ‘429 patent makes no mention of porosity or the production of the wood charcoal substitute for carbon black.

U.S. Pat. No. 8,710,136 B2, entitled “Carbon Blacks Having Low PAH Amounts and Methods of Making Same”, issued on Apr. 29, 2014, to Irina S. Yurovskaya, et al. (the “‘136 patent”), describes a combination of an elastomeric or rubber compound containing a carbon black which is low in PAHs. The ‘136 patent shows the need for low PAH carbon fillers, but it describes the potential carbon blacks as, “a furnace black, channel black, lamp black, thermal black, acetylene black, plasma black, a carbon product containing silicon-containing species, and/or metal containing species.” Further, Yurovskaya et al. specifically disclose “an elastomeric composition or rubber matrix comprising at least one carbon black and at least one elastomer,” but do not describe the production of the low PAH filler itself.

In view of the foregoing, it is apparent that a need exists for a new and useful material which has properties similar to thermal and furnace carbon blacks, but which can be produced renewably and without the emission of fossil carbon dioxide or other pollutants.

### SUMMARY OF THE INVENTION

In an embodiment, the present invention provides a method for the creation of a novel composition of carbon material through the pyrolysis and subsequent treatment of biomass particles under special conditions to create specific properties targeted for use as a filler or pigment in rubber or plastic.

In another embodiment of the present invention, a novel composition of carbon material is provided which has less than 5 μg/kg of PAH and other similar hazardous compounds.

In yet another embodiment of the present invention, a sustainable carbon material is produced from renewable biomass materials which is free of a net release of carbon dioxide or other greenhouse gases into the atmosphere in the life cycle of the product.

Another object of the present invention is to provide a carbon material with substantially different morphology and structure to traditional carbon blacks such that it can provide new and improved properties in blended applications, when used independently or in conjunction with existing fillers, such as clay, silica, and/or carbon black.

These and other advantages and novel features of the present invention will become apparent from the following description of the invention when considered in conjunction with the accompanying drawings and appended claims.

### BRIEF DESCRIPTION OF THE DRAWINGS

Referring now to the attached drawings which form a part of this disclosure:

FIG. 1 is a flow diagram of a process for the production and sizing of a solid carbon material from raw, untreated biomass in accordance with an embodiment; and Biomass is introduced into the carbonization reactor, where it is thermally decomposed at high temperature into solid carbon and wood gas. The wood gas exits the process for other use. The solid carbon is milled, and the milled carbon is then sized for the desired specification. Particles below the desired size are collected as final product, while the oversized particles are re-introduced into the milling step.

FIG. 2 is a flow diagram of a process for the production and sizing of a solid carbon material from wet green biomass in which the biomass is initially dried to remove the moisture and which captures and uses gaseous by-products from a carbonization process to drive the drying process and to generate steam, which is utilized for electrical power generation for the process

### DESCRIPTION OF THE PREFERRED EMBODIMENTS

It should be noted that the present description is by way of instructional examples, and the concepts presented herein are not limited to use or application with any single carbonization method, apparatus, or system. Hence, while the details of the innovation described herein are for the convenience of illustration and explanation with respect to exemplary embodiments, the principles disclosed may be applied to other types and applications of the production of carbon fillers from biomass feedstocks without departing from the scope hereof.

### The Method:

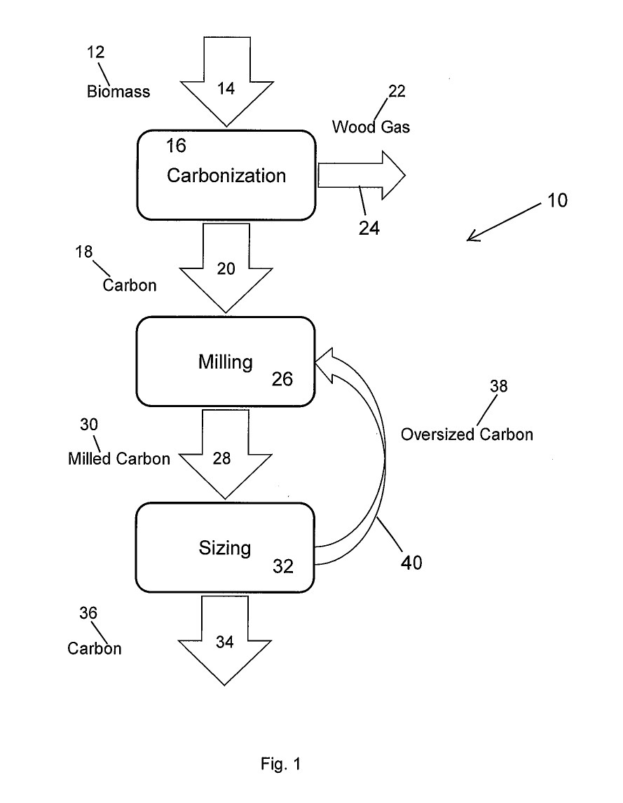

Referring now to FIG. 1, a flow diagram of a process 10 for the production and sizing of a solid carbon material from raw, untreated biomass illustrates the steps thereof in accordance with an embodiment of the instant invention. The initial steps to create the novel composition of matter herein described require the raw untreated biomass to be heated sufficiently to drive off volatile carbon and to create a high purity, high fixed carbon structure, a process known in the art as carbonization or pyrolysis. Prior to carbonization, the biomass feedstock may be sized to a desired fineness of a d50 less than 45 microns before the carbonization step, or, as described below, the sizing may be performed after carbonization. The carbonization may be accomplished through any number of processes which exist in the art, including external heating, steam pyrolysis, or staged pyrolysis as described in Applicant's US Pat. No. 9,505,984 B2 (the “‘984 patent”). Any cost effective method for the creation of biochar or activated carbon would be suitable for this process. In the pyrolysis process, the desired surface area is also created, and over 90% or more of the volatile fraction of the biomass feedstock is removed.

By way of example and not of limitation, using the pyrolysis process as described in the ‘984 patent, untreated biomass 12 is introduced at step 14 to a carbonization reactor 16 to produce carbon having the desired carbonized structure 18 at step 20 and carbonization by-products including wood gas 22 at step 24. The biomass feedstock may be collected from a waste stream or other source at a desired size or fineness which does not require processing for size. Alternatively, the feedstock may be sized to the desired fineness for example, approximately a d50 below approximately 45 microns before the carbonization step. Carbonization is accomplished by pyrolytically decomposing the biomass feedstock at a preselected temperature in a range of approximately 400° C. to approximately 900° C. for a preselected period of time. At least 90% of the volatile fraction in the feedstock is removed. External fuel beyond the chemical energy in the biomass feedstock 12 is not required and additional wood gas 22 is produced which may have a number of economically advantageous uses.

First, it reduces the operating costs since fuel does not need to be burned for heating of the process. The excess wood gas 22 produced by carbonization, which does not drive the carbonization process, can be used to produce electricity, provide heat for biomass drying, or drive other furnaces. Second, it allows for manufacturing facilities to be located close to feedstock supply without need for considering fuel supply. Third, a substantial environmental benefit is realized by not utilizing fossil carbons for fuel or feedstock in carbon end product manufacturing since no fossil CO₂ emission and negligible SO₂ emissions are produced.

During pyrolysis or during a cooking period following pyrolysis, adjustments may be made to the processing atmosphere to create a surface functionality which is biased either towards hydrogen functionality or towards oxygen functionality. Once carbon 18 with the desired structure has been created, it is introduced to a suitable milling apparatus shown at 26 where it is milled to a preselected size appropriate for optimal blending. The milling operation, step 28, may be accomplished by any number of means which exist in the art, including a ball-mill, jet-mill, or air-classifier-mill to produce milled carbon 30. At this stage, particles are fed into a sizing apparatus 32 where they are sized, step 34, to produce the final carbon product 36 having the desired carbonized structure and size. As noted above with respect to the biomass feedstock, here the carbon product may be sized after the carbonization step to a desired fineness of approximately a d50 below approximately 45 microns. The carbon may be separated based on size in order to create various grades of carbon for different uses. For example, the carbon product may be sized to a desired fineness of a d50 less than 45 microns after the carbonization step. Oversized carbon 38 may be returned to the milling apparatus 26 for additional processing as shown by the arrow indicating reprocessing step 40.

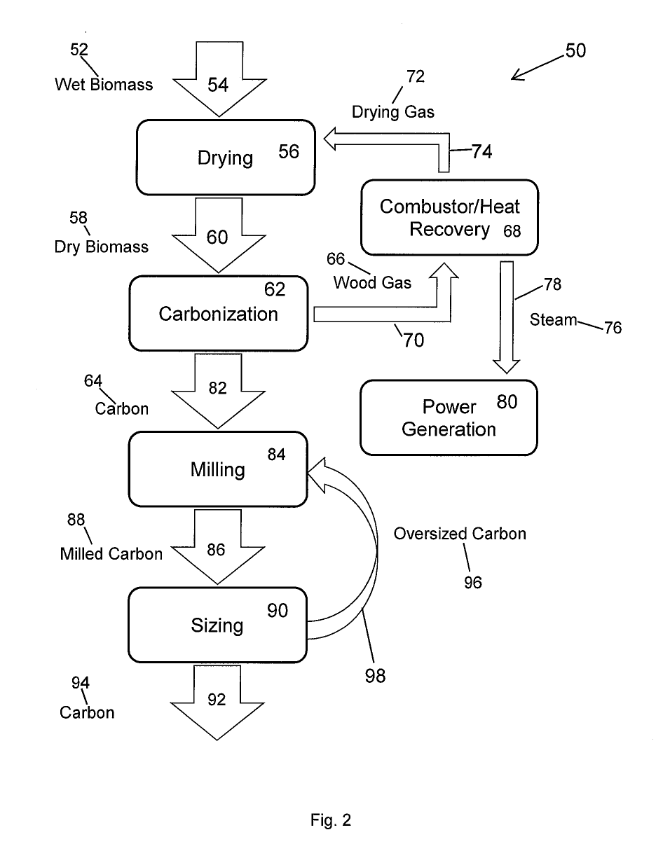

Referring now to FIG. 2, a process flow diagram illustrates the steps of a process 50 for producing and sizing carbon from wet raw biomass feedstock in accordance with an embodiment of the present invention. As described above with respect to the embodiment of FIG. 1, wet or green biomass 52 may be introduced via step 54 to drying apparatus 56 to produce biomass feedstock 58 of a selected moisture content and density.

The dried biomass 58 is introduced via step 60 to a carbonization reactor 62 where it is decomposed at high temperature (between approximately 350° C. and approximately 750° C.) under atmospheric temperature into solid carbon 64 and wood gas 66. The wood gas may be directed to a combustor 68 as shown at step 70 where it is burned for heat recovery, producing hot gas for biomass drying 72, step 74. A portion of the wood gas produced during the carbonization process may also be used to produce steam 76 or other sources of power is directed at step 78 to a power generator 80 to provide electrical or other sources of power for the process.

The solid carbon 64 produced in the carbonization process at 62 is then introduced at step 82 into suitable milling apparatus shown at 84 where it is milled to a preselected size appropriate size for optimal blending. The milling operation, step 86, may be accomplished by any number of means which exist in the art, including a ball-mill, jet-mill, or air-classifier-mill to produce milled carbon 88. At this stage, particles are fed into a sizing apparatus 90 where they are sized, step 92, to produce the final carbon product 94 having the desired carbonized structure and size. The carbon may be separated based on size in order to create various grades of carbon for different uses, and oversized carbon 96 may be returned to the milling apparatus 84 for additional processing as shown by the arrow indicating reprocessing step 98.

The above-described methods do not use or produce any significant quantities of environmentally hazardous chemicals or compounds, nor do they release any fossil carbon dioxide or other greenhouse gases into the atmosphere.

Following manufacture in accordance with either of the processes set forth above, the carbon material may be transported and delivered to a user as a granular powder or as an agglomerated pellet, in either case being free of any significant quantities of environmentally hazardous chemicals or compounds.

### The Product:

The end product material described herein has a number of primary and secondary properties and characteristics which make it ideal for use as a carbon filler material. The primary properties include:

1. A composition of matter or particle created through the pyrolysis of biomass which has a high purity of fixed elemental carbon;

2. A composition of matter or particle created through the pyrolysis of biomass which has a high surface-area-to-volume ratio, in the range of approximately 100 to approximately 600 m²/g.

3. A particle size where 50% or more of the particles (d50 ) are less than 45 microns or pm in size. These carbon particles may be refined further through classification and milling to a desired size for specific applications, including but not limited to particles being no greater than 14 μm or particles of even smaller size, being no greater than 6 μm.

4. A sulfur content below 1%

5. A specific gravity of 1.4 g/cc or lower.

The secondary properties describe a composition of matter created through the pyrolysis of biomass which has been milled to a size and possesses specific properties such as density, hardness and chemical composition to provide superior properties as a reinforcement agent or pigment. These properties include, but are not limited to the functionalization of the carbon surface with hydrogen or oxygen groups to better interact with the compounds with which it is being mixed. The composition may also include a total content of PAHs below 500 parts per billion and specific PAH compound concentrations to lower levels (such as Benzo(a)pyrene below 5 parts per billion). More specifically, the composition of matter has less than 5 μg/kg of polycyclic aromatic hydrocarbons including Acenaphthene, Acenaphthylene, Anthracene, Benzo(a)pyrene, Chrysene, Fluoranthene, Naphthalene, and Pyrene and other similar hazardous compounds. It also has less than 10 mg/kg of heavy metals such as Antimony, Arsenic, Barium, Cadmium, Chromium, Cobalt, Copper, Lead, Nickel, Mercury, or Selenium.

Changes may be made to the foregoing methods, devices and systems without departing from the scope of the present invention. It should be noted that the matter contained in the above description should be interpreted as illustrative and not in a limiting sense. The following claim(s) are intended to cover all generic and specific features described herein as well as statement of the scope of the present invention, which, as a matter of language, might be said to fall therebetween.

What is claimed is:

1. A method for the production from biomass sources of carbon which can be used as a filler, a reinforcing agent, a pigment or a replacement for traditional carbon blacks, the method comprising:
introducing raw untreated biomass feedstock to a carbonization reactor;
pyrolytically decomposing the biomass feedstock in a controlled processing atmosphere at a preselected temperature for a preselected period of time whereby at least 90% of a volatile fraction of the biomass feedstock is removed and a carbon material having a predetermined carbonized structure and carbonization by-products are created;
introducing the carbon material to a milling apparatus;
milling the carbon material to a preselected size;
sizing the milled carbon to produce a high carbon product having a preselected structure and size.

2. The method of claim 1 wherein the preselected temperature is in a range of approximately 400 C. to approximately 900 C.

3. The method of claim 1 including sizing the feedstock material to a desired fineness of approximately a d50 below approximately 45 microns before the carbonization step.

4. The method of claim 1 including sizing the high carbon product to a desired fineness of approximately a d50 below approximately 45 microns after the carbonization step.

5. The method of claim 1 including the step of collecting the biomass feedstock from a waste stream or other source at the desired fineness and which does not require processing for size.

6. The method of claim 1 including the step of selectively modifiying the processing atmosphere during pyrolysis or cooling from pyrolysis to create a surface functionality which is biased more towards hydrogen functionality or oxygen functionality.

7. The method of claim 1 further including processing the carbonization by-products to provide fuel for the generation of heat, steam, electricity or other energy for biomass feedstock processing.

8. The method of claim 1 further including the step of returning oversized milled carbon to the milling apparatus for additional processing.

9. A material which can be used as a filler or reinforcing agent or as a replacement for traditional carbon blacks which had been produced from biomass sources through pyrolytic decomposition, the material having a fixed carbon content greater than approximately 90% and a size or fineness adapted to blend well with rubber and plastic compounds.

10. The material of claim 9 which has a surface area (measured with nitrogen adsorption) of between approximately 100 to approximately 600 m²/g.

11. The material of claim 9 which has a specific gravity of less than 1.4 g/cc.

12. The material of claim 9 wherein the composition of matter has less than 10 mg/kg of heavy metals such as Antimony, Arsenic, Barium, Cadmium, Chromium, Cobalt, Copper, Lead, Nickel, Mercury, or Selenium.

13. The material of claim 12 which has less than 5 μg/kg of polycyclic aromatic hydrocarbons including Acenaphthene, Acenaphthylene, Anthracene, Benzo(a)pyrene, Chrysene, Fluoranthene, Naphthalene, and Pyrene and other similar hazardous compounds.

14. The material of claim 9 which was produced from selected feedstocks in order carry specific properties, such as density, hardness, or chemical composition to provide superior properties as a reinforcing agent.

15. The material of claim 9, which is transported and delivered to the user as a granular powder.

16. The material of claim 6, which is transported and delivered to the user as an agglomerated pellet.

17. The method of claim 1 which does not utilize or produce any significant quantities of environmentally hazardous chemicals or compounds.

18. The method of claim 1 which does not release any fossil carbon dioxide or other greenhouse gases into the atmosphere.
